(19) United States
(12) Patent Application Publication
(10) Pub. No.: US 2024/0110607 A1
(43) Pub. Date: Apr. 4, 2024

(54) Electric Motor Mount

(71) Applicant: The Pullman Company, Milan, OH (US)

(72) Inventors: Zoren E. GASPAR, Huron, OH (US); Md BHUIYAN, Milan, OH (US); Labib MUBASHIR, Milan, OH (US)

(21) Appl. No.: 18/371,076

(22) Filed: Sep. 21, 2023

Related U.S. Application Data
(60) Provisional application No. 63/412,732, filed on Oct. 3, 2022.

(51) Int. Cl. F16F 1/38

(52) U.S. Cl. CPC F16F 1/3835

(57) ABSTRACT

A mounting assembly for a vehicle that includes an inner tube, a damping element couped to the inner tube, and an outer shell that houses each of the inner tube and the damping element. The damping element is formed of a micro-cellular urethane material. The inner tube includes a first tapered surface, a second tapered surface, a third tapered surface, and a fourth tapered surface, and the damping element includes a first axially extending projection that extends outward from the first tapered surface, a second axially extending projection that extends outward from the second tapered surface, a third axially extending projection that extends outward from the third tapered surface, and a fourth axially extending projection that extends outward from the fourth tapered surface. The outer shell compresses each of the first, second, third, and fourth axially extending projections toward a respective tapered surface.

### CROSS-REFERENCE TO RELATED APPLICATIONS

This application claims the benefit of U.S. Provisional Application No. 63/412,732, filed on Oct. 3, 2023. The entire disclosure of the application referenced above is incorporated herein by reference.

### FIELD

The present disclosure relates to a vibration-attenuating mounting assembly.

### BACKGROUND

This section provides background information related to the present disclosure which is not necessarily prior art.

Vehicles experience vibrations during use thereof. As the vehicle moves, exterior forces are applied to the vehicle from, for example, the surface upon which the vehicle is operating. In addition, when a motor of the vehicle is running, forces are generated by the motor that can be transferred to a structure (e.g., frame) of the vehicle. These forces can affect operation of the vehicle, or lead to noise, vibration, and harshness (NVH) conditions that may be undesirable to the operator of the vehicle. Accordingly, the vehicle can include various systems (e.g., suspension systems and mounting assemblies that attach the motor to the structure of the vehicle) that are designed to attenuate the forces applied to the vehicle.

### SUMMARY

This section provides a general summary of the disclosure and is not a comprehensive disclosure of its full scope or all of its features.

According to a first aspect of the present disclosure there is provided a mounting assembly configured to couple a motor to a frame of a vehicle. The mounting assembly may include an inner tube defining an axis; a damping element couped to the inner tube; and an outer shell that houses each of the inner tube and the damping element, wherein the damping element is formed of a micro-cellular urethane material; the damping element includes a plurality of projections that extend radially outward from the inner tube and axially along the axis and a plurality of protuberances that extend radially outward from the inner tube and axially along the axis, wherein adjacent projections are separated from each other by one of the plurality of protuberances; and the outer shell is configured to compress at least one of the plurality of projections or at least one of the protuberances.

According to the first aspect, the outer shell includes a first shell and a second shell that are configured to mate with each other.

According to the first aspect, the plurality of projections and the plurality of protuberances include a first protuberance located between a first projection and a second projection, a second protuberance located between a third projection and a fourth projection, a third protuberance located between the first projection and the fourth projection, and a fourth protuberance between the second axially projection and the third projection, wherein each of the first, second, third, and fourth projections are compressed by the outer shell and each of the first, second, third, and fourth protuberances are spaced apart from an inner surface of the outer shell.

According to the first aspect, each of the first shell and the second shell include a plurality of radially inwardly extending flanges that define a planar surface that is configured to abut against a surface of one of the projections, and restrict axial movement of the damping element relative to the outer shell.

According to the first aspect, each of the projections includes a pair of cut-outs that define a pad of the projection therebetween, and each of the flanges abuts a respective cut-out.

According to the first aspect, at least one of the first shell and the second shell includes a fully-formed radially inwardly extending ridge, and each of the first shell and the second shell include a first half-formed radially inwardly extending ridge and a second half-formed radially inwardly extending ridge; and when the first shell is mated with the second shell, the first half-formed radially inwardly extending ridges abut against each other and the second half-formed radially inwardly extending ridges abut against each other to form a pair of the fully-formed radially inwardly extending ridges.

According to the first aspect, each of the first shell and the second shell includes a fully-formed radially inwardly extending ridge; and the fully-formed radially inwardly extending ridge of the first shell extends axially outward from an edge of the first shell, and the fully-formed radially inwardly extending ridge of the second shell extends axially outward from an edge of the second shell.

According to the first aspect, each of the first half-formed radially inwardly extending ridges and each of the second half-formed radially inwardly extending ridges extend axially outward from edges of each of the first shell and second shell, respectively.

According to the first aspect, each of the first shell and the second shell include a fully-formed radially inwardly extending ridge, and a distance that the fully-formed radially inwardly extending ridge of the first shell extends inward from an interior surface of the first shell is less than a distance that the fully formed radially inwardly extending ridge of the second shell extends inward from an interior surface of the second shell.

According to the first aspect, when the first shell is mated with the second shell, the fully-formed radially inwardly extending ridge of the first shell is configured to abut against the third protuberance without compressing the third protuberance, and the fully-formed radially inwardly extending ridge of the second shell is configured to abut against and compress the fourth protuberance.

According to a second aspect of the present disclosure, there is provided a mounting assembly configured to couple an electric motor to a frame of a vehicle. The mounting assembly may include an inner tube defining an axis; a damping element couped to the inner tube and extending along the axis; and an outer shell that houses each of the inner tube and the damping element, wherein the damping element is formed of a micro-cellular urethane material; the inner tube includes a first tapered surface, a second tapered surface, a third tapered surface, and a fourth tapered surface; the damping element includes a first projection that extends axially along the axis and radially outward from the first tapered surface toward the outer shell, a second projection that extends axially along the axis and radially outward from the second tapered surface toward the outer shell, a third projection that extends axially along the axis and radially outward from the third tapered surface toward the outer shell, and a fourth projection that extends axially along the axis and radially outward from the fourth tapered surface toward the outer shell; and the outer shell compresses each of the first, second, third, and fourth axially extending projections in a direction back toward a respective tapered surface.

According to the second aspect, the outer shell includes a first shell and a second shell that are configured to mate with each other.

According to the second aspect, the damping element includes a first protuberance located between the first projection and the second projection that extends radially outward toward the outer shell, a second protuberance located between the third projection and the fourth projection that extends radially outward toward the outer shell, a third protuberance located between the first projection and the fourth projection that extends radially outward toward the outer shell, and a fourth protuberance between the second projection and the third projection that extends radially outward toward the outer shell, each of the first, second, third, and fourth protuberances being spaced apart from an inner surface of the outer shell.

According to the second aspect, each of the first, second, third, and fourth protuberances are configured to contact the inner surface of the outer shell upon application of vibrations having variable amplitudes to the mounting assembly.

According to the second aspect, the inner tube includes a first axially extending protrusion between the first tapered surface and the fourth tapered surface, and includes a second axially extending protrusion between the second tapered surface and the third tapered surface.

According to the second aspect, the inner tube includes an aperture extending along the axis that is configured for receipt of a fastener that connects the electric motor to the frame of the vehicle.

According to the second aspect, an axial length of the inner tube is greater than an axial length of the damping element.

According to the second aspect, the outer shell includes a contoured inner surface that defines a plurality of planar surfaces that are configured as abutment surfaces that are configured to contact and compress the first, second, third, and fourth axially extending projections.

According to the second aspect, the contoured inner surface defines a plurality of recesses that are spaced apart from the damping element.

According to the second aspect, the damping element includes an annular plate configured to attenuate forces applied axially to the mounting assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a mounting assembly according to a first principle of the present disclosure;

FIGS. 2 to 4 are various perspective views of an inner tube of the mounting assembly illustrated in FIG. 1;

FIGS. 5 and 6 are various perspective views of a damping element of the mounting assembly illustrated in FIG. 1;

FIGS. 7 and 8 are front perspective views of the mounting assembly illustrated in FIG. 1 in an unassembled and assembled state, respectively;

FIG. 9 is a side perspective view of the mounting assembly illustrated in FIG. 1, which connecting a portion of a motor or engine and a frame of a vehicle;

FIG. 10 is a cross-sectional view of the mounting assembly illustrated in FIG. 9;

FIG. 11 is a perspective view of a mounting assembly according to a second principle of the present disclosure;

FIG. 12 is an axial cross-sectional view of the mounting assembly illustrated in FIG. 11;

FIG. 13 is a radial cross-sectional view of the mounting assembly illustrated in FIG. 11;

FIG. 14 is a perspective view of a tube assembly that is part of the mounting assembly illustrated in FIG. 11;

FIG. 15 is an axial cross-sectional view of the tube assembly illustrated in FIG. 14;

FIG. 16 is a front-perspective view of the tube assembly illustrated in FIG. 14;

FIG. 17 is a perspective view of a damping element assembly that is part of the mounting assembly illustrated in FIG. 11;

FIG. 18 is an exploded perspective view of the damping element assembly illustrated in FIG. 17;

FIG. 19 is an axial cross-sectional view of the damping element assembly illustrated in FIG. 17;

FIG. 20 is a cross-sectional view of a combination of the damping element assembly and the tube assembly;

FIG. 21 is a perspective view of a portion of the outer shell that is part of the mounting assembly illustrated in FIG. 11;

FIG. 22 is a perspective view of a mounting assembly according to a third principle of the present disclosure;

FIG. 23 is an exploded perspective view of the mounting assembly illustrated in FIG. 22;

FIG. 24 is a perspective view of a mounting assembly according to a fourth principle of the present disclosure;

FIG. 25 is an exploded perspective view of the mounting assembly illustrated in FIG. 24;

FIG. 26 is a perspective view of a mounting assembly according to a fifth principle of the present disclosure;

FIG. 27 is an exploded perspective view of the mounting assembly illustrated in FIG. 26;

FIG. 28 is a perspective view of a mounting assembly according to a sixth principle of the present disclosure;

FIG. 29 is an exploded perspective view of the mounting assembly illustrated in FIG. 28;

FIG. 30 is a perspective view of a mounting assembly according to a seventh principle of the present disclosure; and

FIG. 31 is a perspective view of a mounting assembly according to an eighth principle of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

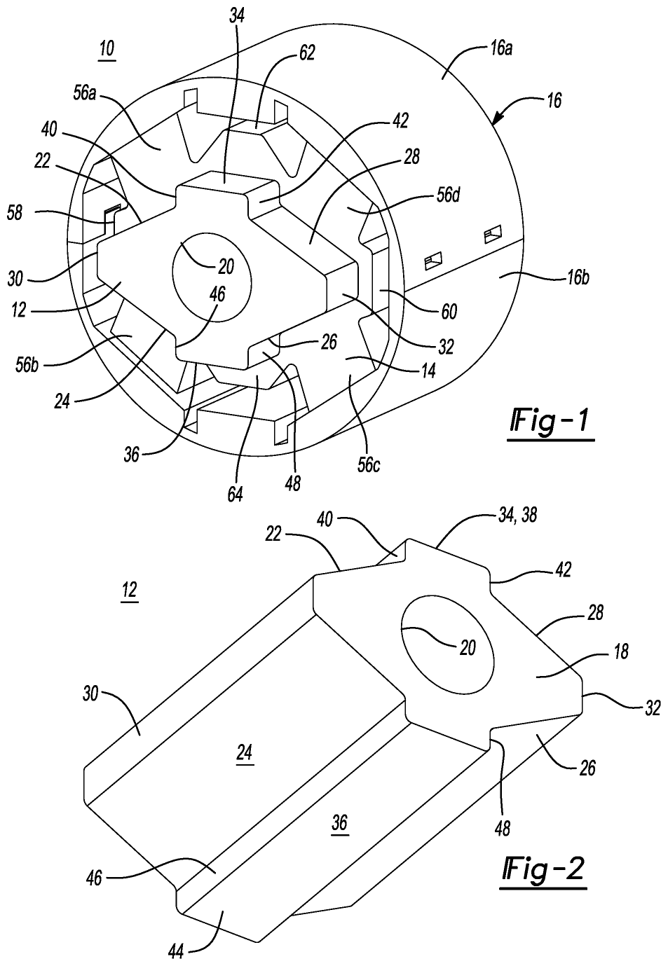

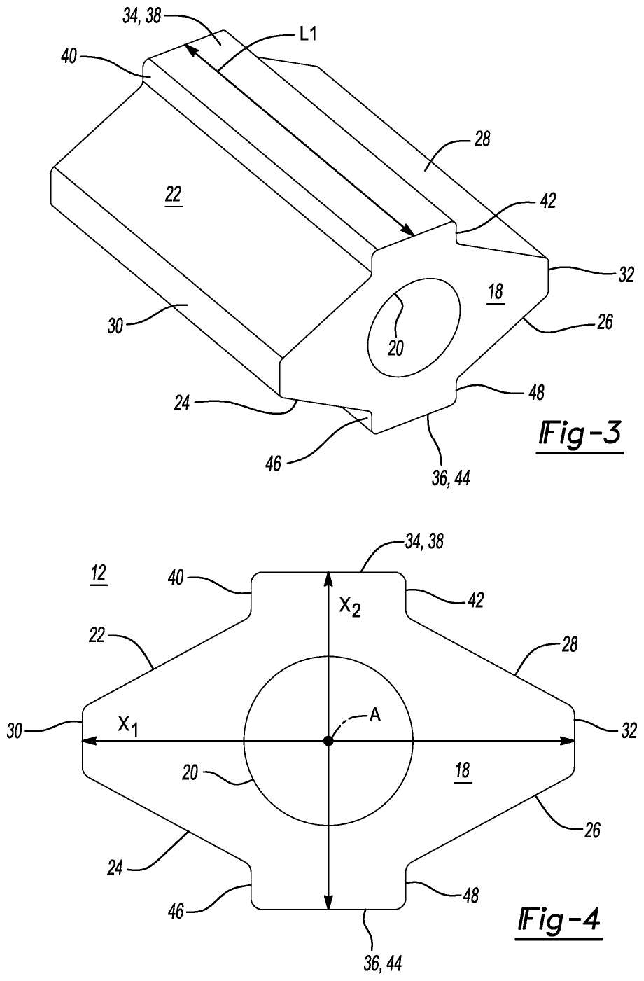

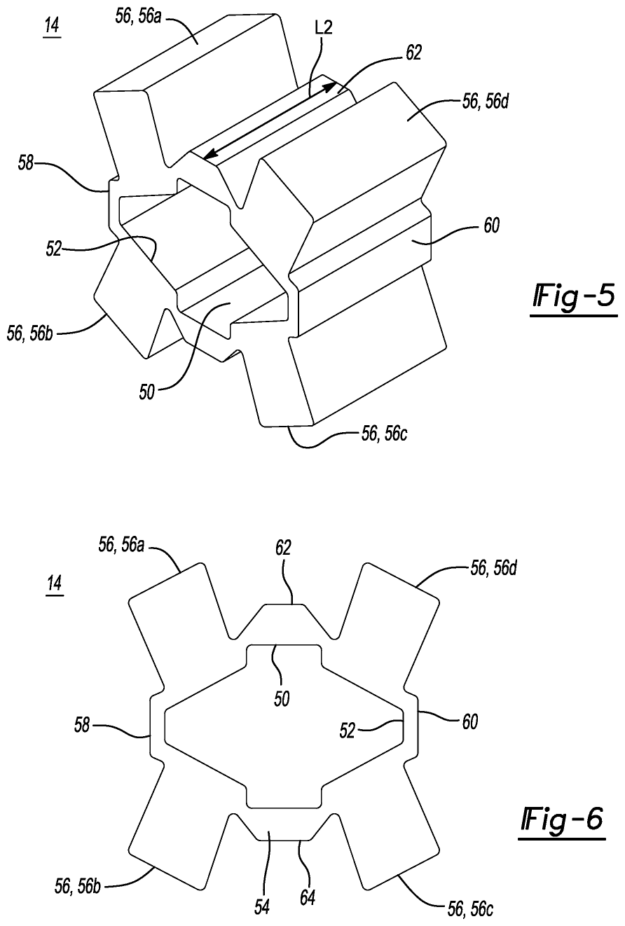

FIGS. 1 to 10 illustrate a mounting assembly 10 according to a first principle of the present disclosure. Mounting assembly 10 includes an inner tube 12, a damping element 14 that is bonded or adhered to inner tube 12, and an outer shell 16. Mounting assembly 10 is configured for damping vibrations generated in a vehicle and may be positioned between a motor or engine (a portion of which is shown at 11 in FIG. 9) of the vehicle (not shown) and a frame or sub-frame 13 of the vehicle. In particular, the vehicle may be an electric vehicle and the motor or engine may be an electric engine.

Mounting assembly 10 is configured for damping vibrations that are applied radially to mounting assembly 10. In this regard, while mounting assembly 10 can damp vibrations that are applied axially to mounting assembly at least to a certain extent, mounting assembly 10 is not designed to extend in a z-axis direction between the motor and the frame of the vehicle. In contrast, mounting assembly 10 is designed to extend in an x- or y-axis direction between the motor and the frame (see, e.g., FIG. 9). It should be understood that the “z-axis direction” is a direction that extends substantially perpendicular to the ground, and the “x- and y-axis directions” are directions that extend substantially parallel with the ground. For example, mounting assembly 10 may extend between the motor 11 and the frame 13 in a fore or aft direction (i.e., y-direction) of the vehicle or between the motor 11 and the frame 13 in a side-to-side direction (i.e., x-direction) of the vehicle rather than in an up-down direction (z-direction).

Inner tube 12 is a rigid member that may be formed of a rigid material such as aluminum or some other type of metal material. As best shown in FIGS. 2 to 4, inner tube 12 has a body 18 that includes an axially extending aperture 20 that extends along a longitudinal axis A and along an entire length L1 of inner tube 12. Aperture 20 is configured for receipt of a fastener 15 (FIG. 9) including a head 17, shank 19, and nut 21 that attaches mounting assembly 10 between the electric motor 11 and the frame 13.

Body 18 includes a first tapered surface 22, a second tapered surface 24, a third tapered surface 26, and a fourth tapered surface 28 that each extend along the entire length L1 of inner tube 12. A first connection surface 30 connects first tapered surface 22 and second tapered surface 24, where first and second tapered surfaces 22 and 24 are tapered in a direction toward each other. A second connection surface 32 connects third tapered surface 26 and fourth tapered surface 28, where third and fourth tapered surfaces 26 and 28 are tapered in a direction toward each other.

A first axially extending protrusion 34 extends along the length L1 of inner tube and between first tapered surface 22 and fourth tapered surface 28. A second axially extending protrusion 36 extends along the length L1 of the inner tube 12 and between the second tapered surface 24 and the third tapered surface 26. First protrusion 34 includes a first planar surface 38 that is connected to first tapered surface 22 by a first side surface 40 and that is connected to fourth tapered surface 28 by a second side surface 42. Second protrusion 36 includes a second planar surface 44 that is connected to second tapered surface 24 by a third side surface 46 and that is connected to third tapered surface 26 by a fourth side surface 48. Tapered surfaces 22, 24, 26, and 28 provide body 18 with a long axis X1 and a short axis X2, where each of the long axis X1 and short axis X2 extend orthogonal relative to longitudinal axis A. Tapered surfaces 22, 24, 26, and 28 are configured for receipt of a force that is transferred to inner tube 12 by damping element 14, which will be described in more detail later.

Now referring to FIGS. 1, 5, and 6, it can be seen that damping element 14 includes an axially extending through-hole 50 that is configured for receipt of inner tube 12 therein. Through-hole 50 is shaped to correspond to the exterior surface of inner tube 12 such that inner tube 12 may be snugly received therein. Thus, through-hole 50 includes an interior surface 52 that is designed to mate with the tapered surfaces 22-28 and the protrusions 34 and 36. Damping element 14 may be formed of a polymeric material. In particular, damping element 14 is formed of a micro-cellular urethane (MCU) material that provides increased damping characteristics in comparison to, for example, a more rigid material such as rubber or some other type of elastomeric material.

As noted above, damping element 14 can be bonded or adhered to inner tube 12. In this regard, inner tube 12 may be placed in a mold (not shown) and the MCU material may subsequently be injected into the mold and bonded to the inner tube 12. Alternatively, damping element 14 may first be formed in the desired shape having through-hole 50, and an adhesive (not shown) may be applied to either the through-hole 50 or the exterior surface of the inner tube 12 and the inner tube 12 inserted into the through-hole 50 where the adhesive will adhere damping element 14 to inner tube 12.

Damping element 14 includes a body 54 (FIG. 6) having a plurality of axially extending projections 56 that extend along an entire length L2 of the damping element 14. A first projection 56a extends outward from body 54 at a location that corresponds to first tapered surface 22 of inner tube 12. A second projection 56b extends outward from body 54 at a location that corresponds to second tapered surface 24. A third projection 56c extends outward from body 54 at a location that corresponds to third tapered surface 26. A fourth projection 56d extends outward from body 54 at a location that corresponds to fourth tapered surface 28. Projections 56 extends between outer shell 16 and inner tube 12 and are the primary features of damping element 14 that dampen vibrations applied to mounting assembly 10, which will be described in more detail later.

An axially extending first protuberance 58 extends outward from body 54 at a location between first and second projections 56a, 56b, and corresponds to a location of first connection surface 30 of inner tube 12. An axially extending second protuberance 60 extends outward from body 54 at a location between third and fourth projections 56c, 56d, and corresponds to a location of second connection surface 32 of inner tube 12. An axially extending third protuberance 62 extends outward from body 54 at a location between first and fourth projections 56a, 56d, and corresponds to a location of first protrusion 34. An axially extending fourth protuberance 64 extends outward from body 54 at a location between second and third projections 56b, 56c, and corresponds to a location of second protrusion 36. As best shown in FIG. 1, the first to fourth protuberances 58, 60, 62, and 64, while extending in a direction toward outer shell 16, are spaced apart from the outer shell 16.

As noted above, the axially extending projections 56 extend outward from body 54 at locations that correspond to the tapered surfaces 22, 24, 26, and 28. The axially extending projections 56, therefore, extend outward form body 54 at angles. For example, using long axis X1 as a basis, fourth projection 56d is located at an angle of about 60 degrees relative to axis X1, first projection 56a is located at an angle of about 120 degrees relative to axis X1, second projection 56b is located at an angle of about 240 degrees relative to axis X1, and third projection 56c is located at an angle of about 300 degrees relative to axis X1. These locations are variable. For example, fourth projection 56d could be located at an angle of about 30 or 45 degrees, and the other projections 56a, 56b, and 56c could be located at similar locations.

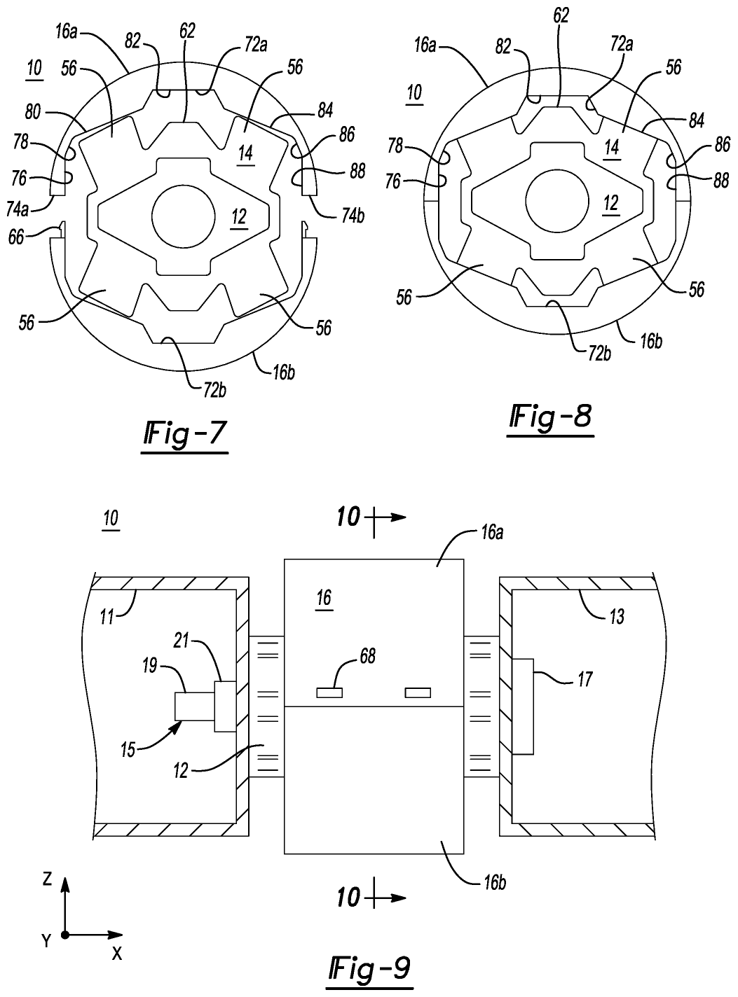

Now referring to FIGS. 7-10, outer shell 16 will be described. Outer shell 16 may be formed of a rigid polymeric material or a metal material. Example polymeric materials include rigid thermoplastic or thermoset materials such as polyamide (e.g., Nylon®) or polystyrene. Example metal materials include aluminum, steel, titanium, and the like.

Outer shell 16 is a hollow cylindrical member that may be formed of a first shell 16a and a second shell 16b that mate to collectively form the hollow cylindrical member. To connect first shell 16a to second shell 16b, second shell 16b may include a plurality (in the illustrated embodiment, four) tabs 66 that are configured to mate with a corresponding aperture 68 (FIG. 9) formed on first shell 16a. When the combination of inner tube 12 and damping element 14 are located in, for example, second shell 16b, the first shell 16a may then be mated to the second shell 16b by inserting the tabs 66 into apertures 68. When first shell 16a is mated with second shell 16b, the axially extending projections 56 will compress. This is best shown in FIGS. 8 and 10 where FIG. 8 shows the projections 56 in a compressed state, and FIG. 10 shows how the projections 56 would extend at 70 but for the contact with the outer shell 16.

The inner surface 72a of first shell 16a and the inner surface 72b of second shell 16b are contoured, as best shown in FIGS. 7, 8, and 10. The inner surfaces 72a and 72b are mirror images of each other, so the only description provided relative to the inner surfaces 72a, 72b will be directed to the inner surface 72a of first shell 16a. Beginning from a first edge 74a of first shell 16a, the inner surface 72a includes a first section 76 that transitions to a second section 78 that is planar and angled relative to first section 76. Second section 78 then transitions to a third section 80 that is planar and angled relative to second section 78 and serves as an abutment surface for first projection 56a. Third section 78 then transitions into a recess 82 that is positioned at a location that corresponds to third protuberance 62. Recess 82 has a depth such that third protuberance 62 is spaced apart from the inner surface 72a of the first shell 16a. It should be understood, however, that third protuberance 62 may contact the inner surface 72a when mounting assembly 10 is subjected to vibrations of greater force. Recess 82 then transitions to a fourth section 84 that is similar to third section 80. That is, fourth section 84 serves as an abutment surface for fourth projection 56d. Fourth section 84 then transitions to a fifth section 86 that is planar and angled relative to fourth section 84 and is similar to second section 78. Lastly, fifth section 86 transitions to a sixth section 88 that is similar to first section 76 and terminates at a second edge 74b of first shell 16a.

The first and sixth sections 76, 88 are located at positions of first shell 16a that correspond to the first and second protuberances 58 and 60 and are spaced apart therefrom. It should be understood, however, that first and second protuberance 58, 60 may contact the inner surface 72a when mounting assembly 10 is subjected to vibrations of greater force in a manner similar to the third and fourth protuberances 62, 64.

During use of mounting assembly 10, vibrations generated by the motor or received by the vehicle through operation thereof will be transferred to the fastener (not shown) that passes through inner tube 12. The force of these vibrations is then transferred from the fastener to the inner tube 12, which then transfers the force to damping element 14. Specifically, the interface between tapered surfaces 22, 24, 26, and 28 and the axially extending projections 56a, 56b, 56c, and 56d, respectively, will transfer the force generated by the vibrations radially outward through the projections 56a-56d to the outer shell 16.

Moreover, due to damping element 14 being formed of a material such as micro-cellular urethane (MCU), damping element 14 provides high damping at lower frequencies and low damping at higher frequencies. This is due to the projections 56a-56d formed of the MCU material being compressed when located within outer shell 16. That is, because damping element 14 is entirely formed of the MCU material, the damping element 14 is not as rigid as a damper that is formed of, for example, a rubber or some other type of elastomeric material, which provides better vibration attenuation at low frequencies and reduced vibration transmission at high frequencies due to the inherent MCU material properties.

In addition, when mounting assembly 10 is subjected to greater vibrations (i.e., vibrations at greater amplitudes or greater frequencies) that compress the projections 56a-56d to an extent that the protuberances 58, 60, 62 and 64 may contact the outer shell 16, it should be understood that protuberances 58-64 are also compressible due to the damping element 14 being formed of the MCU material to permit greater attenuation of the vibrations that are applied to mounting assembly 10. Thus, the mounting assembly 10 is more effective at attenuating vibrations in comparison to a mounting assembly that uses a different material for the damping element 14 and does not have the geometry of the damping element 14.

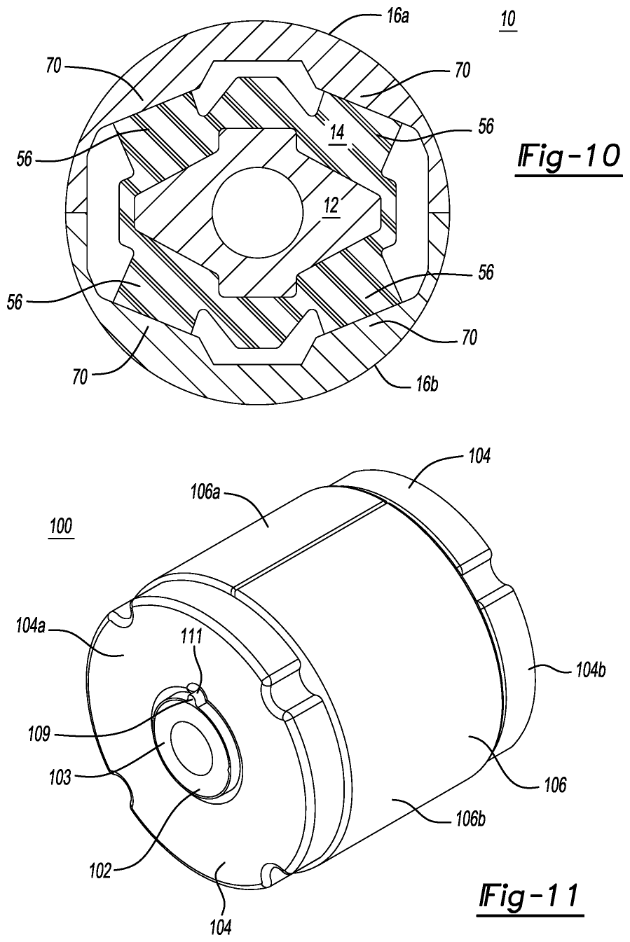

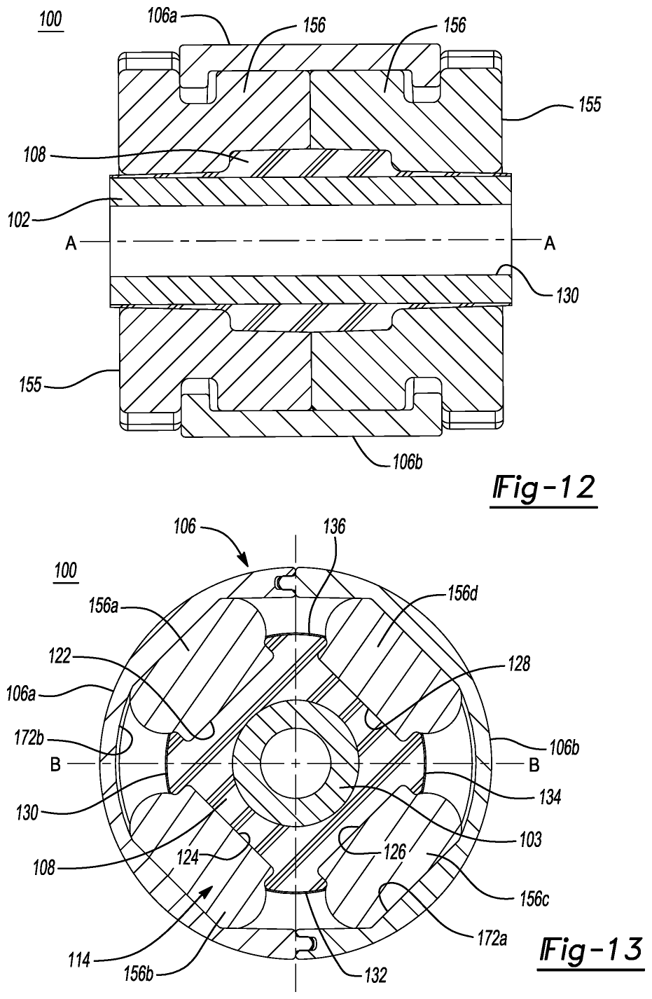

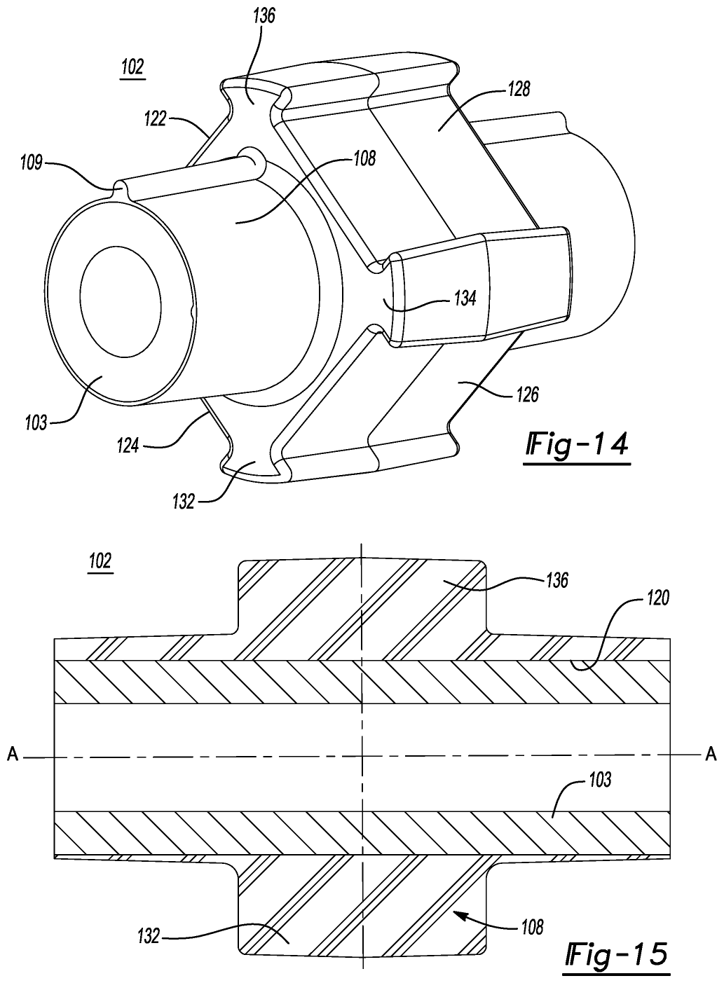

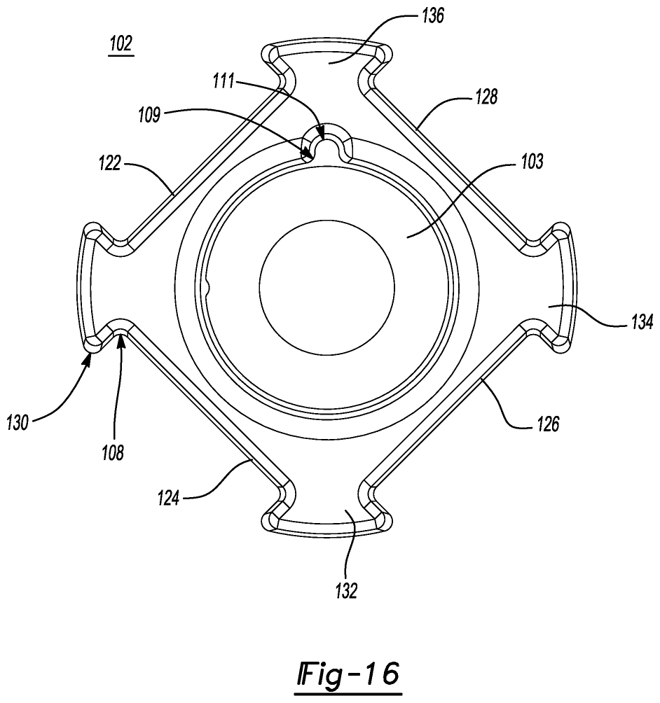

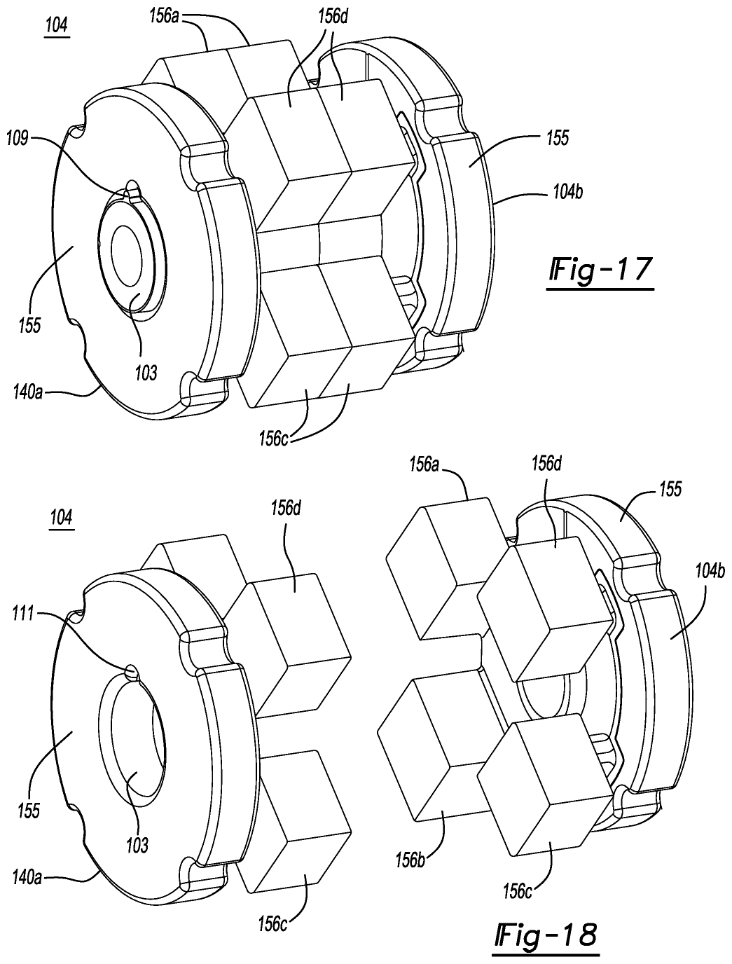

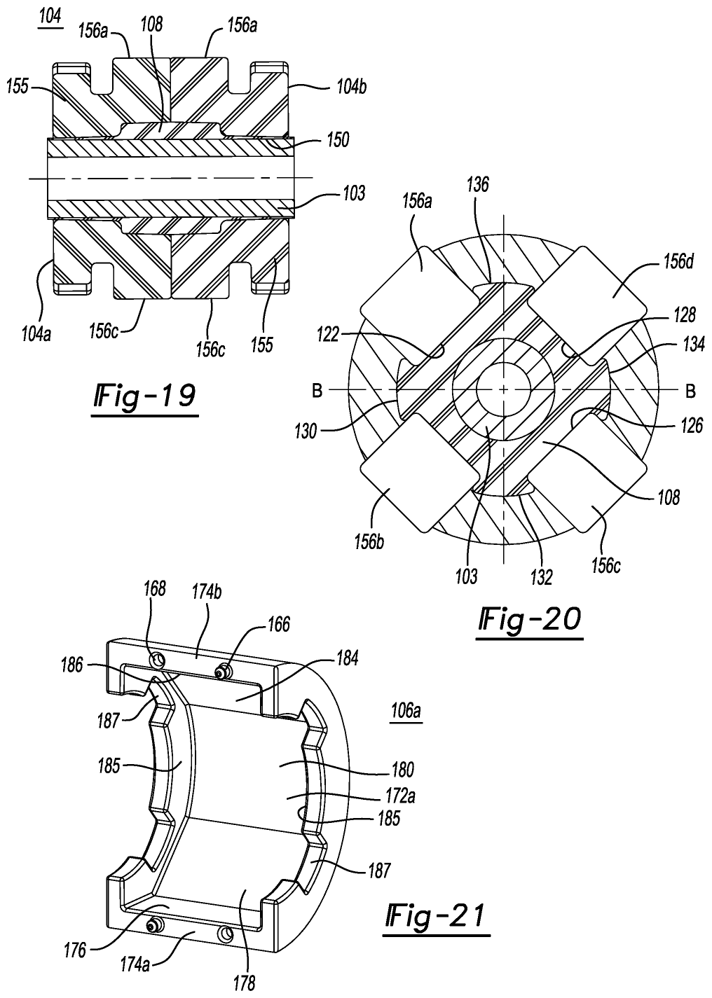

Now referring to FIGS. 11 to 21, a mounting assembly 100 according to a second principle of the present disclosure is illustrated. Mounting assembly 100 includes an inner tube assembly 102 (best shown in FIGS. 14-16), a damping element assembly 104 (best shown in FIGS. 17-20), and an outer shell 106 (best shown in FIGS. 11-13 and 21). Mounting assembly 100 is configured for damping vibrations generated in a vehicle and may be positioned between a motor or engine (not shown) of the vehicle (not shown) and a frame (not shown) or sub-frame (not shown) of the vehicle. In particular, the vehicle may be an electric vehicle and the motor or engine may be an electric engine.

Mounting assembly 100 is configured for damping vibrations that are applied radially to mounting assembly 100. Moreover, as will be described in more detail later, mounting assembly 100 can dampen vibrations that are applied axially to mounting assembly 100 to a greater extent in comparison to the mounting assembly 10 described previously. Similar to mounting assembly 10, mounting assembly 100 is not designed to extend in a z-axis direction between the motor and the frame of the vehicle. In contrast, mounting assembly 100 is designed to extend in a x- or y-axis direction between the motor and the frame.

Inner tube assembly 102 includes a hollow cylindrical tube 103 that may be formed of a rigid material such as aluminum or some other type of metal material. As best shown in FIGS. 14 to 16, inner tube assembly 102 also includes a two-piece polymer body 108 that includes an axially extending aperture 120 that extends along a longitudinal axis A and along an entire length of polymer body 108 and is configured for receipt of hollow cylindrical tube 103 therein. Hollow cylindrical tube 103 is configured for receipt of a fastener (not shown) that attaches mounting assembly 100 between the electric motor and the frame.

Body 108 defines a first tapered surface 122, a second tapered surface 124, a third tapered surface 126, and a fourth tapered surface 128. A first wedge 130 connects first tapered surface 122 and second tapered surface 124, where first and second tapered surfaces 122 and 124 are tapered in a direction toward each other. A second wedge 132 connects second tapered surface 124 and third tapered surface 126, where the second and third tapered surfaces 124 and 126 are tapered in a direction toward each other. A third wedge 134 connects third tapered surface 126 and fourth tapered surface 128, wherein the third and fourth tapered surfaces 126 and 128 are tapered in a direction toward each other. A fourth wedge 136 connects the fourth tapered surface 128 and the first tapered surface 122, wherein the first and fourth tapered surfaces 122 and 128 are tapered in a direction toward each other. In addition, polymer body 108 defines an axially extending nub 109 that is configured to mate with a corresponding recess 111 formed on damping element assembly 104 to properly orient damping element assembly 104 relative to inner tube assembly 102. Tapered surfaces 122, 124, 126, and 128 are configured for receipt of a force that is transferred to inner tube assembly 102 by damping element assembly 104, which will be described in more detail later.

Now referring to FIGS. 17 to 20, it can be seen that damping element assembly 104 includes a first damping element 104a and a second damping element 104b that collectively define an axially extending through-hole 150 that is configured for receipt of inner tube 12 therein. Through-hole 150 is shaped to correspond to the exterior surface of inner tube assembly 102 such that inner tube assembly 102 may be snugly received therein. Damping element assembly 104 may be formed of a polymeric material. In particular, damping element assembly 104 is formed of a micro-cellular urethane (MCU) material that provides amplitude specific damping properties.

Each damping element 104a and 104b is a monolithic body formed of the MCU that includes an annular plate 155 configured to attenuate axial forces (vibrations) applied to mounting assembly 100, includes a plurality of radially outwardly extending projections 156. In the illustrated embodiment, the plurality of projections 156 include first projections 156a that are configured to contact the first tapered surface 122 of inner tube assembly 102; second projections 156b that are configured to contact second tapered surface 124; third projections 156c that are configured to contact third tapered surface 126; and fourth projections 156d that are configured to contact fourth tapered surface 128. Projections 156a-156d extend between outer shell 106 and inner tube assembly 102 and are the primary features of damping element 104 that dampen radially vibrations applied to mounting assembly 100, which will be described in more detail later.

As noted above, the radially outwardly extending projections 156a-156d extend outward at locations that correspond to the tapered surfaces 122, 124, 126, and 128. The projections 156a-156d, therefore, extend radially outward at angles. For example, using the axis B shown in FIG. 20 as a basis, fourth projection 156d is located at an angle of about 45 degrees relative to axis B, first projection 156a is located at an angle of about 135 degrees relative to axis B, second projection 156c is located at an angle of about 225 degrees relative to axis B, and third projection 156c is located at an angle of about 315 degrees relative to axis B. These locations are variable.

Now referring to FIGS. 11-13 and 21, outer shell 106 will be described. Outer shell 106 may be formed of a rigid polymeric material or a metal material. Example polymeric materials include rigid thermoplastic or thermoset materials such as polyamide (e.g., Nylon®) or polystyrene. Example metal materials include aluminum, steel, titanium, and the like.

Outer shell 106 is a hollow cylindrical member that may be formed of a first shell 106a and a second shell 106b that mate to collectively form the hollow cylindrical member. To connect first shell 106a to second shell 106b, each shell 106a and 106b may include a tab 166 that is configured to mate with a corresponding recess 168 formed on the opposing shell 106a or 106b. When the combination of inner tube assembly 102 and damping element assembly 104 are located in, for example, second shell 106b, the first shell 106a may then be mated to the second shell 106b by inserting the tab 166 into the recess 168. When first shell 106a is mated with second shell 106b, the axially extending projections 156a-156d will compress. This is best shown in FIG. 13.

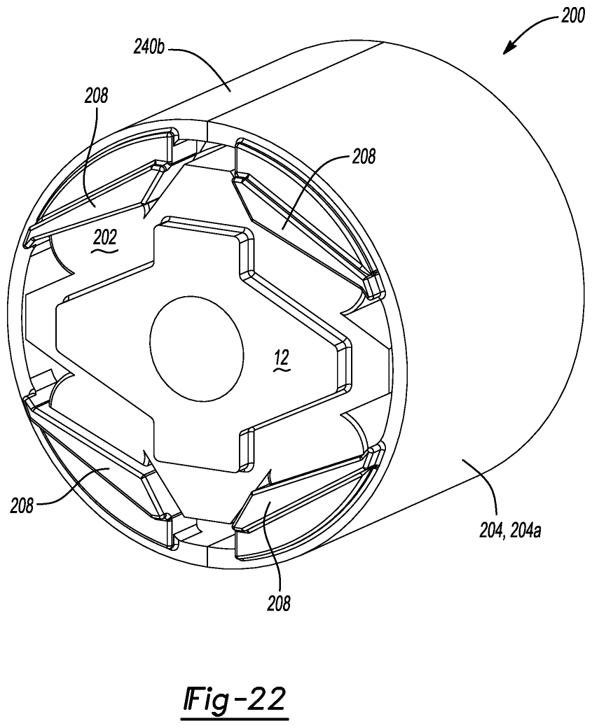

The inner surface 172a of first shell 106a and the inner surface 172b of second shell 106b are contoured, as best shown in FIGS. 13 and 21. The inner surfaces 172a and 172b are mirror images of each other, so the only description provided relative to the inner surfaces 172a, 172b will be directed to the inner surface 172a of first shell 16a. Beginning from a first edge 174a of first shell 106a, the inner surface 172a includes a first section 176 that is cylindrical. First section 176 transitions to a second section 178 that is planar and angled relative to first section 176 and serves as an abutment surface for first projection 156a. Second section 178 then transitions to a third section 180 that is planar and angled relative to second section 178. Third section 180 then transitions into a fourth section 184 that is similar to second section 178. That is, fourth section 184 serves as an abutment surface for fourth projection 156d. Fourth section 84 then transitions to a fifth section 186 that is similar to first section 176 (i.e., cylindrical) and terminates at second edge 174b. Each shell 106a and 106b also includes a pair of annular abutment surfaces 185 that are configured to abut against annular plates 155. Abutment surfaces 185 include cutouts 187 that are shaped to permit projections 156a-156d to pass therethrough when assembling mounting assembly 100.

During use of mounting assembly 100, vibrations generated by the motor or received by the vehicle through operation thereof will be transferred to the fastener (not shown) that passes through inner tube assembly 102. The force of these vibrations is then transferred from the fastener to the inner tube assembly 102, which then transfers the force to damping element assembly 104. Specifically, the interface between tapered surfaces 122, 124, 126, and 128 and the radially extending projections 156a, 156b, 156c, and 156d, respectively, will transfer the force generated by the vibrations radially outward through the projections 156a-156d to the outer shell 106. Moreover, annular plates 155 are configured to attenuate any axial forces that are applied to mounting assembly 100.

Moreover, due to damping element 104 being formed of a material such as micro-cellular urethane (MCU), damping element 104 provides high damping at lower frequencies and low damping at higher frequencies. This is due to the projections 156a-156d formed of the MCU material being compressed when located within outer shell 106. That is, because damping element 104 is entirely formed of the MCU material, the damping element 104 is not as rigid as a damper that is formed of, for example, a rubber or some other type of elastomeric material, which provides better vibration attenuation at low frequencies and reduced vibration transmission at high frequencies due to the inherent MCU material properties.

Now referring to FIGS. 22-31, a number of modified embodiments that are similar to the embodiment illustrated in FIGS. 1-10 are illustrated. Each of the modified embodiments include features that adjust the rates at which the mounting assembly can attenuate vibrations that are applied to the mounting assembly. More particularly, as will be described in more detail below, each of the inner tube, the damping element, and outer shell can be modified to adjust the manner in which the mounting assembly attenuates vibrations that are applied to mounting assembly. In this manner, a mounting assembly can be selected for a specific type of vehicle (e.g., sedan versus sport utility vehicle) such that the vibration damping characteristics of the mounting assembly are more directly tailored to the specific type of vehicle. In this regard, in a vehicle that is more apt to be used in harsher driving conditions (e.g., off-road), it may be desirable for the mounting assembly to provide stiffer rates of vibration attenuation in comparison to a vehicle that is not apt to be driven in harsher driving conditions (e.g., only driven on paved surface streets).

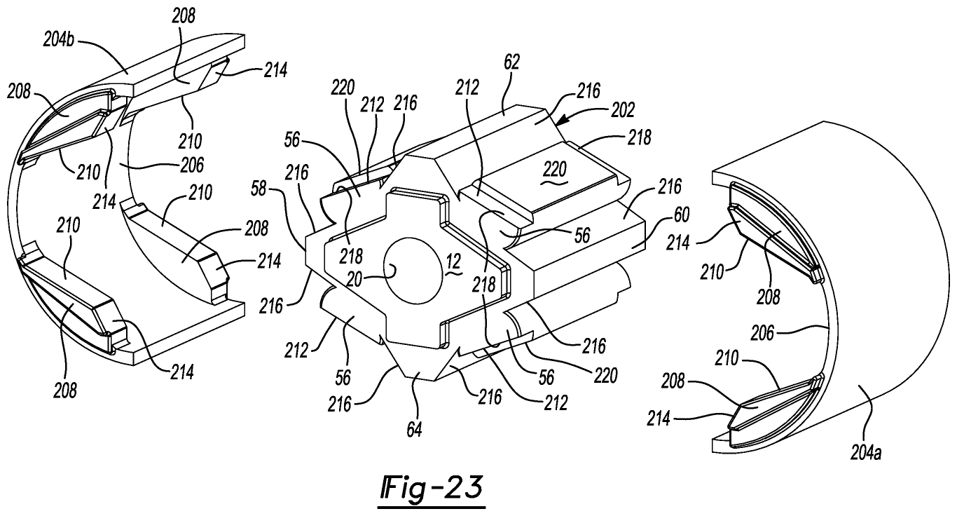

FIGS. 22 and 23 illustrate a mounting assembly 200 according to a third principle of the present disclosure. Mounting assembly 200 includes the same inner tube 12 as mounting assembly 10 such that description thereof relative to this embodiment will be omitted. The primary differences between mounting assembly 200 and mounting assembly 10 is that mounting assembly 200 includes a modified damping element 202 and a modified outer shell 204. Damping element 202 is modified to account for the modified outer shell 204.

Outer shell 204 is a hollow cylindrical member that may be formed of a first shell 204a and a second shell 204b that mate to collectively form the hollow cylindrical member. Although not shown in FIGS. 22 and 23, it should be understood that to connect first shell 204a to second shell 204b, second shell 204b may include a plurality of tabs that are configured to mate with a corresponding aperture formed on first shell 204a in manner similar to that shown in FIGS. 7 and 9 (see, e.g., tabs 66 and apertures 68 in FIGS. 7 and 9). When the combination of inner tube 12 and damping element 202 are located in, for example, second shell 204b, the first shell 204a may then be mated to the second shell 204b by inserting the tabs into apertures.

Each of the first shell 204a and second shell 204b include a smooth interior surface 206 and a plurality (in the illustrated embodiment, four) of radially inwardly extending flanges 208. Flanges 208 each include a planar surface 210 that is configured to rest against a surface 212 of a projection 56 of damping element 202. Planar surfaces 210 are angled to correspond to an angle of surface 212 of the corresponding projection 56 such that planar surface 210 is substantially co-planar with surface 212 of projection 56 when damping element 202 is located within outer shell 204 and angled surface 210 abuts surface 212. Flanges 208 also include a first angled surface 214 that is configured to abut against a second angled surface 216 of protuberances 58, 60, 62, and 64 of damping element 202.

In a manner similar to mounting assembly 10, vibrations transferred from a vehicle frame to a fastener (not shown) located in aperture 20 are transferred to inner tube 12, which then transfers the vibrations to damping element 202. The vibrations transferred to damping element 202 travel radially outward from inner tube 12 through projections 56, which then transfer the vibrations to the planar surface 210 and first angled surfaces 214 of flanges 208 that abut surfaces 212 of projections 56 and second angled surfaces 216 of protuberances 58-64.

Damping element 202 is substantially similar to damping element 14 and may be formed of MCU. As can be seen in FIGS. 22 and 23, however, the projections 56 each include a pair of cut-outs 218 that define a pad 220 therebetween. Cut-outs 218 define surfaces 212 that abut planar surfaces 210. Moreover, inasmuch as planar surfaces 210 of flanges 208 are abutted against surfaces 212 with pad 202 therebetween, it should be understood that flanges 208 are configured to restrict axial movement of damping element 202 within outer shell 204 during use of mounting assembly 200.

Pads 202 and protuberances 58-64 may be spaced apart from interior surface 206 of outer shell 204 during use of mounting assembly 200. Notwithstanding, it should be understood that pads 202 and protuberances 58-64 may abut interior surface 206 during periods of intense vibration. Nonetheless, inasmuch as pads 202 are spaced apart from interior surface 206, the rates at which mounting assembly 200 attenuates vibrations is different from the mounting assembly 10 (i.e., not as stiff).

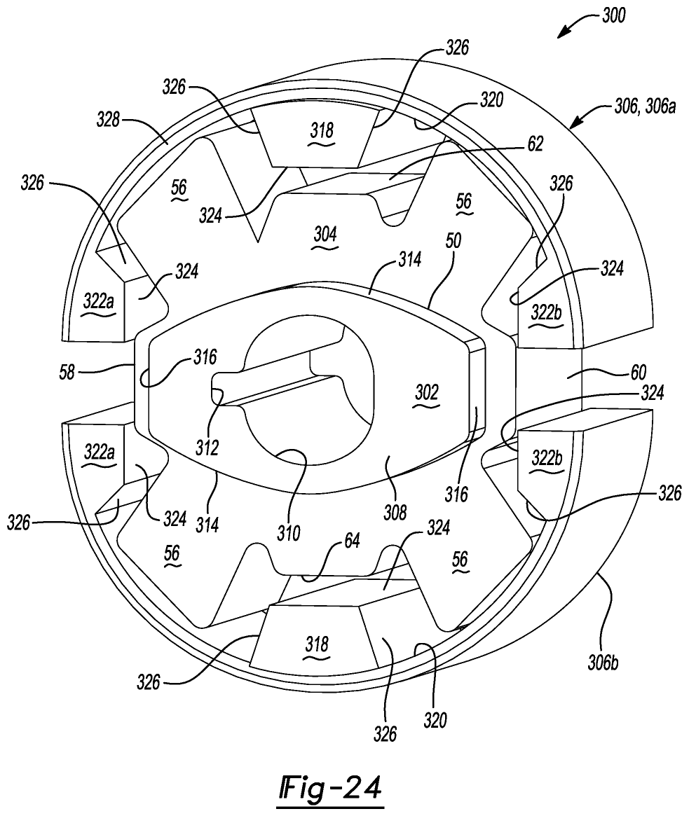

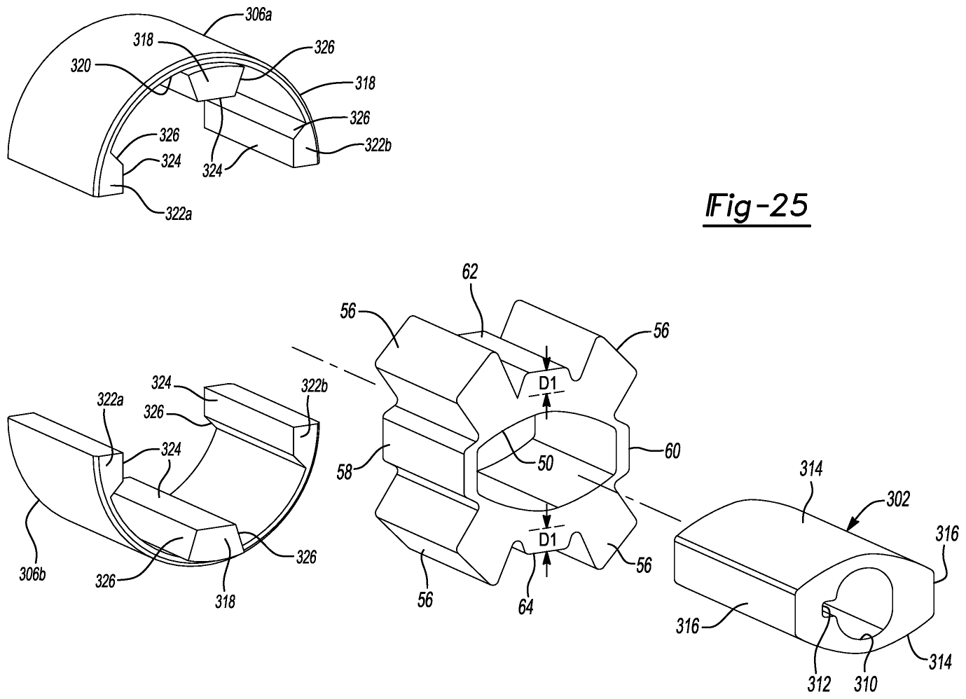

Now referring to FIGS. 24 and 25, a mounting assembly 300 according to a fourth principle of the present disclosure is illustrated that is also similar to mounting assembly 10. In this regard, mounting assembly 300 includes an inner tube 302, a damping element 304, and an outer shell 306 including first shell 306a and a second shell 306b. The primary differences between mounting assembly 300 and mounting assembly 10 is that mounting assembly 300 includes a modified inner tube 302 and a modified outer shell 306. Damping element 304 is substantially similar to damping element 14, but includes a modified through-hole 50 to account for the modified inner tube 302.

Inner tube 302 includes a body 308 defining an axially extending aperture 310 that is configured for receipt of a fastener (not shown) that couples mounting assembly 300 to a frame or sub-frame (not shown) of a vehicle (not shown). Aperture 310 may include a radially outwardly extending slot 312 configured for receipt of a radially outwardly extending rib (not shown) that may be part of fastener (not shown). Body 308 includes a pair of arced outer surfaces 314 that are connected by a pair of flats 316. The geometry of inner tube 302 provided by arced outer surfaces 314 and flats 316 assist the rate at which mounting assembly 300 may attenuate vibrations.

Damping element 304, as noted above, is similar to damping element 14 with the exception of a differently shaped through-hole 50 that is now shaped to account for the geometry of inner tube 302. As can be seen in the illustrated embodiment, however, damping element 304 includes a plurality of outwardly extending projections 56 and protuberances 58-64 like damping element 14. Damping element 304 may also be formed of MCU.

Outer shell 306 is a hollow cylindrical member that may be formed of a first shell 304a and a second shell 304b that mate to collectively form the hollow cylindrical member. Although not shown in FIGS. 24 and 25, it should be understood that to connect first shell 304a to second shell 304b, second shell 304b may include a plurality of tabs that are configured to mate with a corresponding aperture formed on first shell 304a in manner similar to that shown in FIGS. 7 and 9 (see, e.g., tabs 66 and apertures 68 in FIGS. 7 and 9). When the combination of inner tube 302 and damping element 304 are located in, for example, second shell 304b, the first shell 304a may then be mated to the second shell 304b by inserting the tabs into apertures.

Each of first shell 304a and second shell 304b may include a plurality of axially extending ridges 318 that extend radially inward from an interior surface 320. Specifically, first shell 304a and second shell 304b include a fully formed axially extending ridge 318 that is configured to abut against and compress one of the protuberances (e.g., 62 and 64 in the illustrated embodiment), and a pair of half-formed axially extending ridges 322a and 322b. When first shell 306a is mated with second shell 306b, half-formed ridge 322a of first shell 306a will abut half-formed ridge 322a of second shell 306b to collectively form a fully formed axially extending ridge 318 that will abut against and compress protuberance 58. Similarly, when first shell 306a is mated with second shell 306b, half-formed ridge 322b of first shell 306a will abut half-formed ridge 322b of second shell 306b to collectively form a fully formed axially extending ridge 318 that will abut against and compress protuberance 60.

Ridges 318 include an abutment surface 324 spaced apart from interior surface 320 and a pair of side surfaces 326 that connect abutment surface 324 to interior surface 320. In essence, ridges 318 are trapezoidal shaped, and a width of abutment surfaces 324 is substantially equal to a width of protuberances 58-64. While ridges 324 that are formed from half-formed ridges 322a and 322b are substantially similar to fully formed ridges 318 that abut against protuberances 62 and 64, it should be understood that fully formed ridges 318 that abut against protuberances 62 and 64 extend axially outward from edge 328 of shell 306 while ridges 318 formed from half-formed ridges 322a and 322b do not extend axially outward from edge 328.

Projections 56 may abut against and be compressed by interior surface 320 when first shell 306a is mated with second shell 306b. Because projections 56 and protuberances 58-64 are each compressed by features of outer shell 306, mounting assembly 300 provides much stiffer rates of attenuating vibrations in comparison to, for example, mounting assemblies 10 and 200. Moreover, because inner tube 302 includes arced surfaces 314 and flats 316, the vibrations transmitted to inner tube 302 are more evenly spread out to projections 56 and protuberances 58-64 in comparison to the embodiments shown in FIGS. 1-10, 22, and 23.

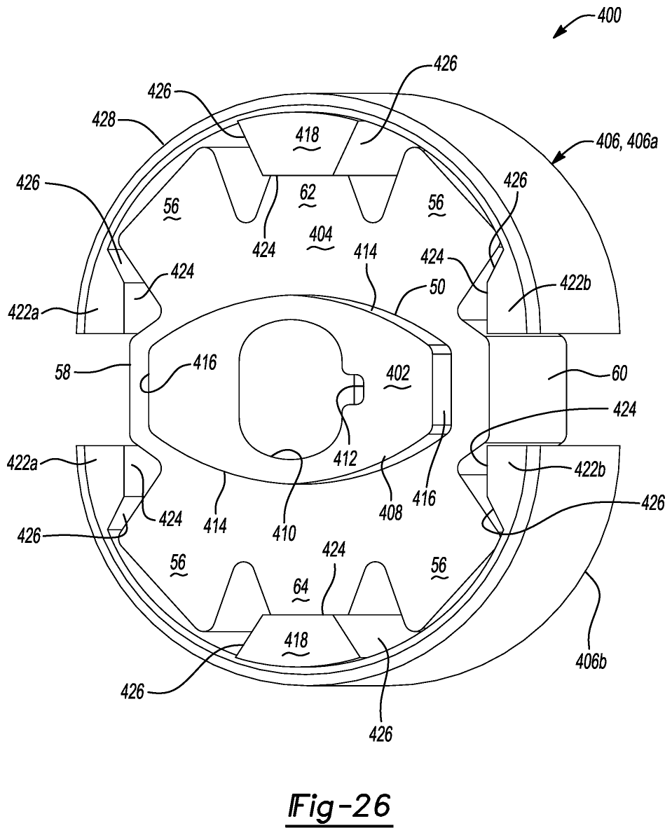

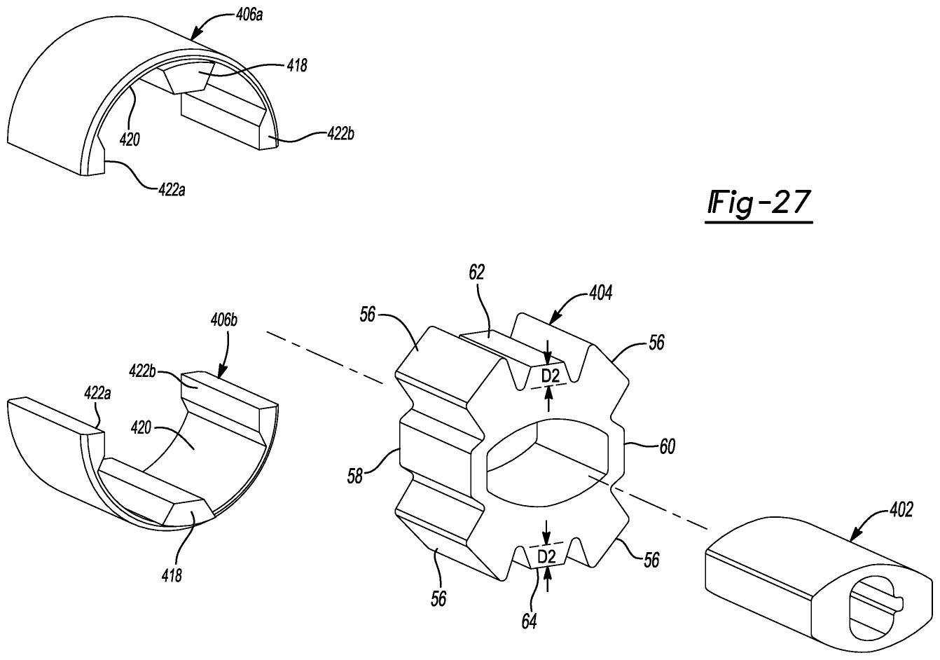

Now referring to FIGS. 26 and 27, a mounting assembly 400 according to a fifth principle of the present disclosure is illustrated that is similar to mounting assembly 300. In this regard, mounting assembly 400 includes an inner tube 402, a damping element 404, and an outer shell 406 including first shell 406a and a second shell 406b. Inasmuch as inner tube 402 and outer shell 406 are essentially the same as those shown in FIGS. 24 and 25, description thereof will be omitted while noting that the features shown in FIGS. 24 and 25 include reference numbers that start with “4” rather than “3” like in FIGS. 24 and 25.

The primary differences between mounting assembly 400 and mounting assembly 300 is that mounting assembly 400 includes a modified damping element 404 that may be formed of MCU and is substantially similar to damping element 304, but includes modified protuberances 62 and 64. In this regard, the protuberances 62 and 64 extend radially outward from inner tube 402 to a greater extent in comparison to the protuberances 62 and 64 illustrated in FIGS. 24 and 25. By increasing the distance D2 that protuberances 62 and 64 extend radially outward in comparison to the distance D1 shown in FIG. 25, a greater amount of compression of protuberances 62 and 64 is achieved when damping element 404 is located within outer shell 406, which adjusts the damping characteristics of damping element 404 (i.e., damping element 404 is even stiffer in comparison to damping element 304).

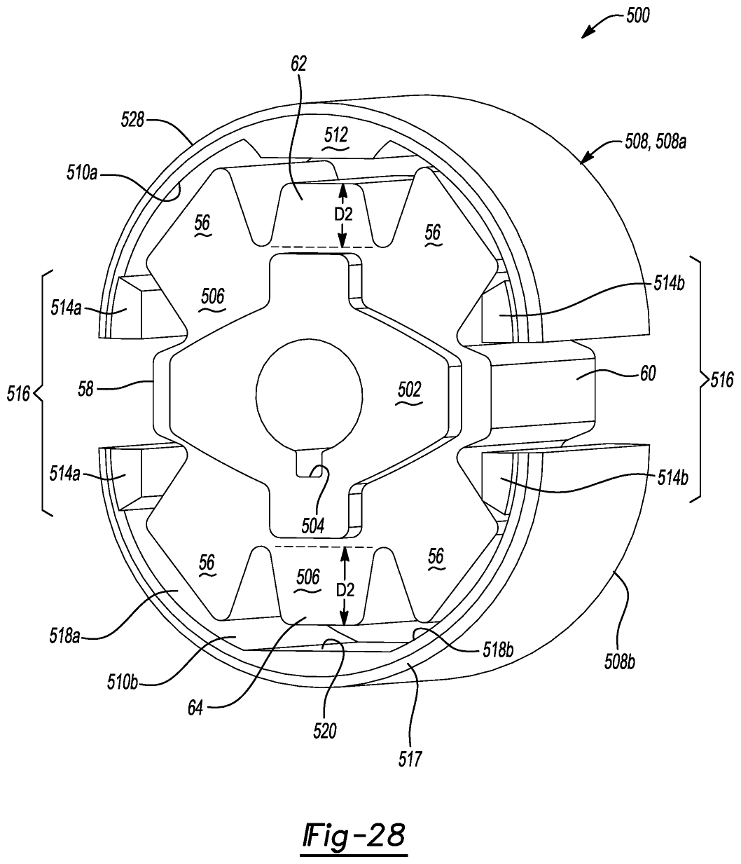

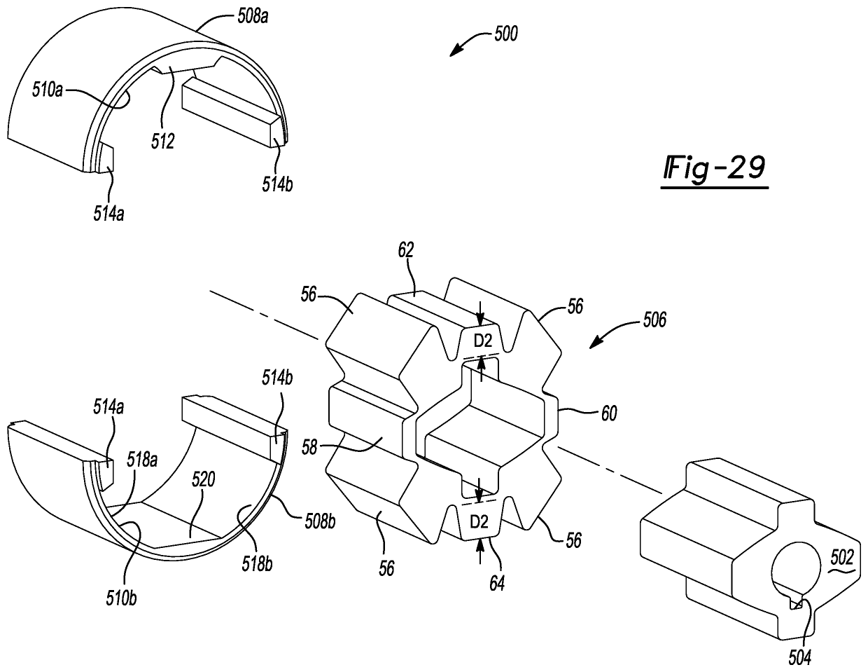

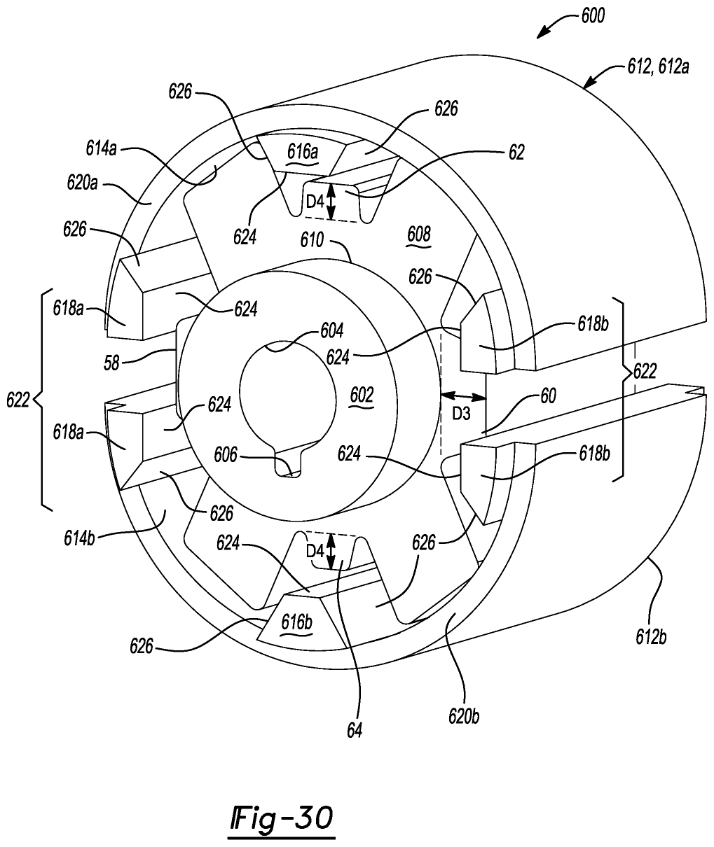

Now referring to FIGS. 28 and 29, a mounting assembly 500 according to a sixth principle of the present disclosure is illustrated. Mounting assembly 500 includes an inner tube 502 that is the same as the inner tube 12 shown in FIG. 1 (albeit with an axially extending slot 504 similar to the slot 312 shown in FIG. 24), a damping element 506, and an outer shell 508 including a first outer shell 508a and a second outer shell 508b. Damping element 506 is substantially the same as damping element 404 (i.e., has protuberances 62 and 64 that extend radially outward at the distance D2) shown in FIGS. 27 and 28, and may be formed of MCU. The primary differences between mounting assembly 500 and mounting assembly 10 are directed to the outer shell 508.

First and second outer shells 508a and 508b collectively form a cylindrical member when mated together. First outer shell 508a includes an interior surface 510a that includes a first radially inwardly extending fully formed ridge 512, and a pair of half-formed ridges 514a and 514b. Second outer shell 508b also includes an interior surface 510b and a pair of half-formed ridges 514a and 514b that, which first shell 508a is mated with second shell 508b, will abut against each other to form a second axially extending fully formed ridges 516. Ridge 512 is designed to abut against and compress protuberance 62, while ridges 516 are designed to abut against and compress protuberances 58 and 60 of damping element 506 when first and second outer shells 508a and 508b are mated together. In the illustrated embodiment ridges 516 extend axially outward from an edge 517 of outer shell 508, while ridge 512 does not.

Second outer shell 508b does not include a first radially inwardly extending fully formed ridge 512. In contrast, the interior surface 510b includes a first cylindrical section 518a inboard from half-formed ridge 514a that transitions to a planar section 520, which then transitions to second cylindrical section 518b located inboard from second half-formed ridge 514b. Planar section 520 is configured to abut against but not compress protuberance 64 when first and second outer shells 508a and 508b are mated together. The use of first inwardly extending fully formed ridge 512 on first shell 508a that compresses protuberance 62 and planar section 520 that does not compress protuberance 64 changes the rate at which mounting assembly 500 can attenuate vibrations. That is, mounting assembly 500 is less stiff in comparison to the mounting assemblies 300 and 400.

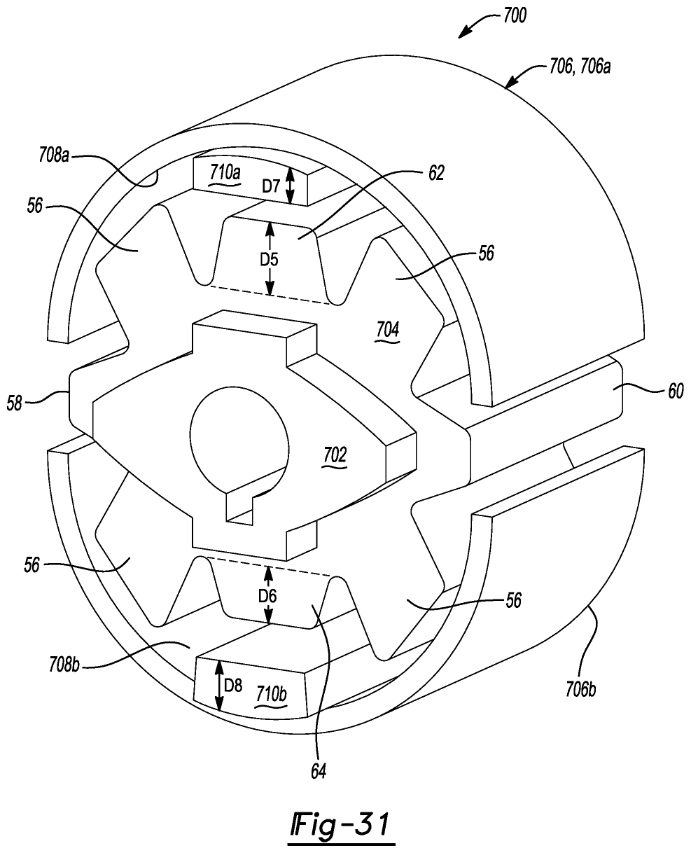

Now referring to FIG. 30, a mounting assembly 600 according to a seventh principle of the present disclosure is illustrated. Mounting assembly 600 includes a cylindrical inner tube 602 having an axially extending aperture 604 that includes an axially extending slot 606. A damping element 608 that may be formed of MCU is bonded to inner tube 602 that is similar to damping element 14 with the exception of including an axially extending through-hole 610 that is shaped to correspond to cylindrical inner tube 602. Cylindrical inner tube 602 and damping element 608 are located within an outer shell 612 including a first outer shell 612a that mates with a second outer shell 612b. Outer shell 612 is similar to outer shell 306 illustrated in FIGS. 24 and 25.

In this regard, first outer shell 612a includes an interior surface 614a having an axially extending fully-formed ridge 616a and a pair of axially extending half-formed ridges 618a and 618b. Half-formed ridges 618a and 618b extend axially outward from an edge 620a of first outer shell 612a. Second outer shell 612b includes an interior surface 614b having an axially extending fully-formed ridge 616b and a pair of axially extending half-formed ridges 618a and 618b. Half-formed ridges 618a and 618b extend axially outward from an edge 620b of first outer shell 612b. When first shell 612a is mated with second shell 612b, half-formed ridges 618a and 618b will abut against each other to form ridges 622 that are configured to abut against and compress protuberances 58 and 60. In this regard, protuberances 58 and 60 extend further radially outward at a distance D3 in comparison to a distance D4 that protuberances 62 and 64 extend radially outward such that fully-formed ridges 616a and 616b, while configured to abut against protuberances 62 and 64, will not compress protuberances 62 and 64 when first outer shell 612a is mated with second outer shell 612b. Ridges 616a, 616b, and 622 are each essentially trapezoid shaped and include an abutment surface 624 spaced apart from interior surfaces 614a and 614b and a pair of side surfaces 626 that connect abutment surface 624 to interior surfaces 614a and 614b. Inasmuch as protuberances 58 and 60 are compressed while protuberances 62 and 64 are not when first outer shell 612a is mated with second outer shell 612b, the rate at which mounting assembly 600 will attenuate vibrations will be different from mounting assemblies 10, 200, 300, 400, and 500.

Now referring to FIG. 31, a mounting assembly 700 according to an eighth principle of the present disclosure is illustrated. Mounting assembly 700 includes an inner tube 702 that is similar to inner tube 12 shown in FIG. 1, a damping element 704 that may be formed of MCU, and an outer shell 706 including a first shell 706a and a second shell 706b. Inasmuch as inner tube 702 is similar to those described above, no further description of this feature will be provided.

First and second outer shells 706a and 706b each include an interior surface 708a and 708b, respectively. Interior surface 708a includes an axially extending ridge 710a and interior surface 708b includes an axially extending ridge 710b. Ridges 710a and 710b, however, are different from each other because protuberances 62 and 64 of damping element 704 are different. In this regard, instead of protuberances 62 and 64 extending radially outward from inner tube 702 to the same extent, protuberance 62 extends outward from inner tube 702 to a greater extent (D5) in comparison to protuberance 64 (D6). Thus, a distance D7 that ridge 710a extends outward from interior surface 706a is less than a distance D8 that ridge 710b extends outward from interior surface 706b.

Projections 56 may abut against interior surfaces 708a and 708b of first and second outer shells 706a and 706b when first and outer shells 706a and 706b are mated together or may be spaced apart therefrom. Similarly, protuberances 58 and 60 may abut against interior surfaces 708a and 708b of first and second outer shells 706a and 706b when first and outer shells 706a and 706b are mated together or may be spaced apart therefrom. By having protuberances 62 and 64 in combination with ridges 710a and 710b that are different, the damping characteristics of mounting assembly 700 are different from the other embodiments described above.

While each of the mounting assemblies 10, 200, 300, 400, 500, 600, and 700 each have different damping characteristics, it should be understood that various features of one embodiment (i.e., the flanges 208 and pad 220 of mounting assembly 200) can also be incorporated into the remaining embodiments. That is, while mounting assemblies 10, 300, 400, 500, 600, and 700 do not include flanges 208 nor a damping element having pads 220 and cut-outs 212, it should be understood that the mounting assemblies 10, 300, 400, 500, 600, and 700 can include these features if desired to limit axial movement of the damping element when located in the outer shells thereof. Moreover, any configuration for the inner tube can be selected for each of the embodiments and this selection can be determined based on the desired damping characteristics.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mounting assembly configured to couple a motor to a frame of a vehicle, comprising:
an inner tube defining an axis;
a damping element couped to the inner tube; and
an outer shell that houses each of the inner tube and the damping element,
wherein the damping element is formed of a micro-cellular urethane material;
the damping element includes a plurality of projections that extend radially outward from the inner tube and axially along the axis and a plurality of protuberances that extend radially outward from the inner tube and axially along the axis, wherein adjacent projections are separated from each other by one of the plurality of protuberances; and
the outer shell is configured to compress at least one of the plurality of projections or at least one of the protuberances.

2. The mounting assembly according to claim 1, wherein the outer shell includes a first shell and a second shell that are configured to mate with each other.

3. The mounting assembly according to claim 2, wherein the plurality of projections and the plurality of protuberances include a first protuberance located between a first projection and a second projection, a second protuberance located between a third projection and a fourth projection, a third protuberance located between the first projection and the fourth projection, and a fourth protuberance between the second axially projection and the third projection, wherein each of the first, second, third, and fourth projections are compressed by the outer shell and each of the first, second, third, and fourth protuberances are spaced apart from an inner surface of the outer shell.

4. The mounting assembly according to claim 3, wherein each of the first shell and the second shell include a plurality of radially inwardly extending flanges that define a planar surface that is configured to abut against a surface of one of the projections, and restrict axial movement of the damping element relative to the outer shell.

5. The mounting assembly according to claim 4, wherein each of the projections includes a pair of cut-outs that define a pad of the projection therebetween, and each of the flanges abuts a respective cut-out.

6. The mounting assembly according to claim 3, wherein at least one of the first shell and the second shell includes a fully-formed radially inwardly extending ridge, and each of the first shell and the second shell include a first half-formed radially inwardly extending ridge and a second half-formed radially inwardly extending ridge; and
when the first shell is mated with the second shell, the first half-formed radially inwardly extending ridges abut against each other and the second half-formed radially inwardly extending ridges abut against each other to form a pair of the fully-formed radially inwardly extending ridges.

7. The mounting assembly according to claim 6, wherein each of the first shell and the second shell includes a fully-formed radially inwardly extending ridge; and
the fully-formed radially inwardly extending ridge of the first shell extends axially outward from an edge of the first shell, and the fully-formed radially inwardly extending ridge of the second shell extends axially outward from an edge of the second shell.

8. The mounting assembly according to claim 6, wherein each of the first half-formed radially inwardly extending ridges and each of the second half-formed radially inwardly extending ridges extend axially outward from edges of each of the first shell and second shell, respectively.

9. The mounting assembly according to claim 3, wherein each of the first shell and the second shell include a fully-formed radially inwardly extending ridge, and a distance that the fully-formed radially inwardly extending ridge of the first shell extends inward from an interior surface of the first shell is less than a distance that the fully formed radially inwardly extending ridge of the second shell extends inward from an interior surface of the second shell.

10. The mounting assembly according to claim 9, wherein when the first shell is mated with the second shell, the fully-formed radially inwardly extending ridge of the first shell is configured to abut against the third protuberance without compressing the third protuberance, and the fully-formed radially inwardly extending ridge of the second shell is configured to abut against and compress the fourth protuberance.

11. A mounting assembly configured to couple an electric motor to a frame of a vehicle, comprising:
an inner tube defining an axis;
a damping element couped to the inner tube and extending along the axis; and
an outer shell that houses each of the inner tube and the damping element,
wherein the damping element is formed of a micro-cellular urethane material;
the inner tube includes a first tapered surface, a second tapered surface, a third tapered surface, and a fourth tapered surface;
the damping element includes a first projection that extends axially along the axis and radially outward from the first tapered surface toward the outer shell, a second projection that extends axially along the axis and radially outward from the second tapered surface toward the outer shell, a third projection that extends axially along the axis and radially outward from the third tapered surface toward the outer shell, and a fourth projection that extends axially along the axis and radially outward from the fourth tapered surface toward the outer shell; and
the outer shell compresses each of the first, second, third, and fourth axially extending projections in a direction back toward a respective tapered surface.

12. The mounting assembly according to claim 11, wherein the outer shell includes a first shell and a second shell that are configured to mate with each other.

13. The mounting assembly according to claim 11, wherein the damping element includes a first protuberance located between the first projection and the second projection that extends radially outward toward the outer shell, a second protuberance located between the third projection and the fourth projection that extends radially outward toward the outer shell, a third protuberance located between the first projection and the fourth projection that extends radially outward toward the outer shell, and a fourth protuberance between the second projection and the third projection that extends radially outward toward the outer shell, each of the first, second, third, and fourth protuberances being spaced apart from an inner surface of the outer shell.

14. The mounting assembly according to claim 11, wherein each of the first, second, third, and fourth protuberances are configured to contact the inner surface of the outer shell upon application of vibrations having variable amplitudes to the mounting assembly.

15. The mounting assembly according to claim 11, wherein the inner tube includes a first axially extending protrusion between the first tapered surface and the fourth tapered surface, and includes a second axially extending protrusion between the second tapered surface and the third tapered surface.

16. The mounting assembly according to claim 11, wherein the inner tube includes an aperture extending along the axis that is configured for receipt of a fastener that connects the electric motor to the frame of the vehicle.

17. The mounting assembly according to claim 11, wherein an axial length of the inner tube is greater than an axial length of the damping element.

18. The mounting assembly according to claim 11, wherein the outer shell includes a contoured inner surface that defines a plurality of planar surfaces that are configured as abutment surfaces that are configured to contact and compress the first, second, third, and fourth axially extending projections.

19. The mounting assembly according to claim 18, wherein the contoured inner surface defines a plurality of recesses that are spaced apart from the damping element.

20. The mounting assembly according to claim 11, wherein the damping element includes an annular plate configured to attenuate forces applied axially to the mounting assembly.
